(19) United States
(12) Patent Application Publication
(10) Pub. No.: US 2007/0068155 A1
(43) Pub. Date: Mar. 29, 2007

(54) Variable-throat exhaust tuebocharger and method for manufacturing constituent members of variable throat mechanism

(76) Inventors: Noriyuki Hayashi, Nagasaki-shi (JP); Seiichi Ibaraki, Nagasaki-shi (JP); Yasuaki Jinnai, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/509,636

(22) Filed: Aug. 25, 2006

(30) Foreign Application Priority Data
Aug. 25, 2005 (JP) 2005-243829

(51) Int. Cl. F02D 23/00

(52) U.S. Cl. 60/602

(57) ABSTRACT

A variable-throat exhaust turbocharger can be provided, in which is used a means to reduce wear of the contact surfaces of the connection pin parts which are formed integral with the lever plates or the drive ring and the grooves into which the connection pin parts are engaged, and which has a means to prevent slipping out of the drive ring from the nozzle mount toward the lever plate to prevent probable occurrence of fail in action of the variable nozzle mechanism caused by the slipping out of the drive ring is provided by the invention. In the invention, the connection pin parts to make connection between the lever plates and drive ring of the variable throat mechanism are formed integral with either the lever plates or the drive ring by extrusion or by precision casting, and at least the connection pin parts or grooves into each of which each of the connection pin parts is engaged are treated with surface hardening including diffusion coating.

### BACKGROUND OF THE INVENTION

1. Field of the Invention

The present invention is applied to exhaust turbochargers for internal combustion engines and relates to the construction of a drive ring and lever plates of a variable-throat exhaust turbocharger equipped with a variable throat mechanism for varying the blade angle of a plurality of nozzle vanes and to an assembling method of the variable throat mechanism.

2. Description of the Related Art

There has been proposed an art relating to the construction of a drive ring and lever plates of a variable-throat turbocharger equipped with a variable throat mechanism for varying the blade angle of a plurality of nozzle vanes in Japanese Laid-Open Patent Application No. 2002-285804 (hereafter referred to as patent literature 1) applied for by the applicant of the present invention. There is also known Japanese Laid-Open Patent Application No. 2002-332866 (hereafter referred to as patent literature 2).

In the art disclosed in the patent literature 1, the turbocharger comprises a plurality of nozzle vanes rotatably supported by a nozzle mount fixed to a turbine casing and a variable throat mechanism which comprises an annular drive ring rotatable by means of an actuator, and lever plates, each of which lever plates has a groove at its one end side to be engaged with each of connection pins of the drive ring to be connected thereto, whereby the blade angle of the nozzle vanes is varied by rotating the drive ring to swing each of the lever plates, the blade angle being varied by the swing of the lever plates, wherein the connection pin or pins are formed either on the lever plate or on the drive ring by extrusion or by precision casting such that the connection pin or pins are formed in one piece with parent material, i.e. the lever plate or drive ring.

In the art disclosed in the patent literature 2, the turbocharger comprises variable blade angle nozzle vanes for adjusting the flow rate of the exhaust gas exhausted from an engine and introduced into the turbocharger to rotate the turbine rotor, a turbine frame which rotatably supports the variable blade angle nozzle vanes arranged at the peripheral part of the exhaust turbine, and a variable throat mechanism for rotating the nozzle vanes to adjust the flow rate of the exhaust gas, whereby the velocity of exhaust gas is increased by throttling the exhaust flow by the variable blade angle nozzle vanes so that high output can be obtained even at low rotation speed, and constituent members of an exhaust guide assembly of the turbocharger are surface-treated to coat the surfaces with carbide or nitride.

However, in the art of the patent literature 1, the connection pin or pins are formed either on the lever plate or on the drive ring by extrusion or by precision casting such that the connection pin or pins are formed in one piece with parent material, i.e. the lever plate or drive ring, but there is disclosed no countermeasure to deal with wear of the connection pin and groove of the link plate in which the connection pin is engaged.

Further, in the art, the drive ring is disposed adjacent to the nozzle mount in axial direction between the side face of the lever plate and the side face of the nozzle mount, but

there is disclosed no countermeasure to prevent slipping-off of the drive ring from the nozzle mount towards the lever plate side.

In the art disclosed in the patent literature 2 is taught surface-treating of the constituent members of the exhaust guide assembly to coat the surfaces with carbide or nitride, but concretively only the coating of the variable blade angle nozzle vanes and the turbine frame is recited, and surface treating of transmission members for transmitting rotational force to the variable blade angle nozzle vanes via movable members is not disclosed.

Further, in the art of the patent literature 2, a ring member is provided to sandwich a rotating member between the ring member and a flange of the turbine frame and push the rotating member towards the turbine frame to prevent the rotating member from moving apart from the turbine frame. Therefore, it is necessary to provide the ring member, resulting in an increase in cost and weight, and further resulting in complication in assembling.

### SUMMARY OF THE INVENTION

The present invention was made in light of the problem in prior art to improve on the art disclosed in the patent literature 1 and 2. The object of the invention is to provide a variable-throat exhaust turbocharger in which connection pin parts which are formed integral with the lever plates or the drive ring and grooves into which the connection pin parts are engaged are treated to reduce abrasion of the contact surfaces of them, and which has a means to prevent slipping out of the drive ring from the nozzle mount toward the lever plate side to prevent probable occurrence of fail in action of the variable nozzle mechanism caused by the slipping out of the drive ring.

To attain the object, the present invention proposes a variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes, wherein a connection pin is formed integral with said lever plate by extrusion or by precision casting as a connection pin parts of the lever plate or connection pins are formed integral with said drive ring by extrusion or by precision casting as connection pin parts of the drive ring, wherein at least either the connection pin part of the lever plate/pin parts of the drive ring or grooves of the drive ring/groves of the lever plates into which the connection pin parts are engaged are treated with surface hardening including diffusion coating.

In the invention, it is preferable concretively that said drive ring is disposed between said lever plates and nozzle mount side by side with the lever plates and nozzle mount in axial direction thereof, and a connection pin part or parts are formed protruding from a side face of the lever plate or the drive ring and integral with the material of the lever plate or the drive ring, whereby the connection pin parts of the lever plates or pin parts of the drive ring are engaged into the grooves of the drive pins or grooves of the lever plates.

The invention proposes as a method for manufacturing a variable-throat exhaust turbocharger equipped with a variable throat mechanism constructed as mentioned above, in which a connection pin part is formed on a lever plate in one piece with the lever plate by pressing a spot on a flat face thereof to allow the pin part to be protruded from the other side flat face thereof or is formed by precision casting on a flat face of a lever plate in one piece with the lever plate, or a plurality of connection pin parts are formed on a drive ring in one piece with the drive ring by pressing a plurality of spots on a flat face thereof to allow the pin parts to be protruded from the other side flat face of the drive ring or are formed by precision casting on a flat face of a drive ring in one piece with the drive ring, then at least either the connection pin part of the lever plate/pin parts of the drive ring or grooves of the drive ring/groves of the lever plates are treated with surface hardening including diffusion coating.

According to the invention, the connecting pin parts can be easily formed integral with the parent material, the lever plates or drive ring, by using as material of the lever plate or the drive ring steel material tough but relatively soft and easy to process by extrusion and applying extrusion forming to either the lever plates or drive ring, or by precision casting. Further, by treating at least the connection pin parts or the grooves, into which the connection pin parts are to be engaged, with surface hardening including diffusion coating, their contact surfaces are increased in hardness and abrasion of the contact surfaces is reduced.

Thus, the connection pin part of each of the lever plates or parts of the drive ring can be easily formed integral with each of the lever plates or drive ring by extrusion consisting of one stage of processing or by precision casting while attaining high durability of the contact surfaces of the connection pin parts and grooves by increasing the hardness of the contact surfaces to suppress abrasion of the contact surfaces, with the result that assembling man-hours and assembling cost can be reduced and the number of parts and manufacturing cost of the parts can be reduced compared with a variable threat mechanism in which the connection pins are provided separately and fixed to the lever plates or drive ring.

In the invention, it is preferable that said drive ring is disposed between said lever plates and nozzle mount side by side with the lever plates and nozzle mount in axial direction thereof, and rivets are fixed to the nozzle mount at its outer side face so that the outer side face of the drive ring can comes into contact with the seating faces of the rivets thereby to prevent the drive ring from moving axially.

Further, it is preferable that recesses are formed to stride across the outer side face of the drive ring and outer side face of the nozzle mount and the head of each of the rivets is received in each of the recesses.

According to the invention like this, slipping out of the drive ring in axial direction can be positively prevented by such an extremely compact, cost saving, and light-in-weight means as to fix a plurality of rivets to the side face of the nozzle mount, with the result that occurrence of failed action of the nozzle throat mechanism caused by slipping out of the drive ring in axial direction can be prevented.

It is preferable that said drive ring is disposed between said lever plates and nozzle mount side by side with the lever plates and nozzle mount in axial direction thereof, and a plurality of partial circumferential grooves are provided at the outer side part of the nozzle mount, thereby receiving the drive ring in the partial circumferential grooves and preventing the drive ring from moving in axial direction.

It is also preferable that a plurality of engaging portions are provided, the engaging portions being composed of convex portions and concave portions provided either to the drive ring or nozzle mount respectively, so that the drive ring can be fitted to the nozzle mount by matching the convex portions and concave portions and shifting axially the drive ring relative to the nozzle mount, whereby the drive ring is allowed to be engaged into said partial circumferential grooves by shifting the drive ring in rotation direction after the drive ring is fitted to the nozzle mount.

A method of manufacturing a variable-throat exhaust turbocharger equipped with a variable throat mechanism constructed as mentioned above is characterized in that; a drive ring is disposed between said lever plates and nozzle mount, the nozzle mount being provided with a plurality of partial circumferential grooves at the outer side part thereof, side by side with the lever plates and nozzle mount in axial direction thereof, and a plurality of engaging portions are provided, the engaging portions being composed of convex portions and concave portions provided either to the drive ring or nozzle mount respectively, so that the drive ring can be fitted to the nozzle mount by matching the convex portions and concave portions and shifting axially the drive ring relative to the nozzle mount, whereby the drive ring is allowed to be engaged into said partial circumferential grooves by shifting the drive ring in rotation direction by a certain angle after the drive ring is fitted to the nozzle mount thereby to prevent slipping out axially of the drive ring, and said lever plates are attached to said drive ring and connected with nozzle shafts of the nozzle vanes, the nozzle shafts penetrating the nozzle mount, with the nozzle mount sandwiched with the lever plates and nozzle vanes.

According to the invention, the drive ring can be positively prevented from slipping out in axial direction by such a manner that require no additional part and therefore does not result in increase in the number of parts and cost, by engaging the drive ring in the partial circumferential grooves formed at the side part of the nozzle mount, and occurrence of fail in action of the variable throat mechanism can be prevented.

Further, it is preferable that a coating layer is formed either on the surface of the connection pin part or on the surface of the groove into which the connecting part is engaged by PVD processing (physical vapor deposition processing) or by CVD (chemical vapor deposition processing).

According to the invention like this, by forming a hard coating layer on the contact surface of the connection pin part and the groove into which the connection pin part is engaged by PVD or CVD processing, the wear resistance of the contact surface is increased.

According to the present invention, hardness of the contact surface of the connection pin part and the groove into which the connection pin part is engaged can be increased by treating the contact surface with surface hardening including diffusion coating. Therefore, each of the connection pin parts can be easily formed integral with each of the lever plates or drive ring by extrusion consisting of one stage of processing or by precision casting while attaining high durability of the contact surface by increasing the hardness of said contact surface to suppress abrasion of the contact surface, with the result that assembling man-hours and assembling cost can be reduced and the number of parts and manufacturing cost of parts can be reduced compared with a variable threat mechanism in which the connection pins are provided separately and fixed to the lever plates or drive ring.

As to surface hardening, in the case of steel-to-steel contact, the contact surface tends to be seriously worn by the occurrence of adhesion(adhesive wear), but when the surface of a member of contacting members is treated with surface hardening, the surface is hardened by the generation of ceramics or intermetallic compounds on the surface and adhesive wear is alleviated. As surface coarsening caused by sliding contact is prevented by surface hardening, occurrence of scratch on the surface can be lessened and occurrence of abrasive wear can be alleviated even when the surface of the other member of contacting members is not treated with surface hardening.

Therefore, reduction of wear of the contact surface can be expected by treating only the surface of a member of contacting members with surface hardening.

Further, according to the invention, the drive ring can be positively prevented from slipping out in axial direction and occurrence of fail in action of the variable throat mechanism can be prevented, by such an extremely compact and cost saving manner as to fix a plurality of rivets to a side face of the nozzle mount, or by such a manner that requires no additional part and therefore does not result in increase in the number of parts and cost by engaging the drive ring into the partial circumferential grooves formed at a side part of the nozzle mount.

### BRIEF DESCRIPTION OF THE DRAWINGS

FIG. 1A is a front view of the first embodiment of the variable throat mechanism of the present invention viewed from the lever plate side, and FIG. 1B is a sectional view along line A-A in FIG. 1A.

FIG. 2A is a front view of the second embodiment of the variable throat mechanism of the present invention viewed from the lever plate side, and FIG. 2B is a sectional view along line A-A in FIG. 2A.

FIG. 3A is a front view of the third embodiment of the variable throat mechanism of the present invention viewed from the lever plate side, FIG. 3B is a sectional view along line A-A in FIG. 2A, and FIG. 3C is a sectional view as along line C-C in FIG. 3A of a modification of the third embodiment.

FIG. 4A is a front view of the second embodiment of the variable throat mechanism of the present invention viewed from the lever plate side, and FIG. 4B is a sectional view along line D-D in FIG. 4A.

FIG. 5 is a longitudinal sectional view of the variable-throat turbocharger equipped with the variable throat mechanism according to the present invention.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

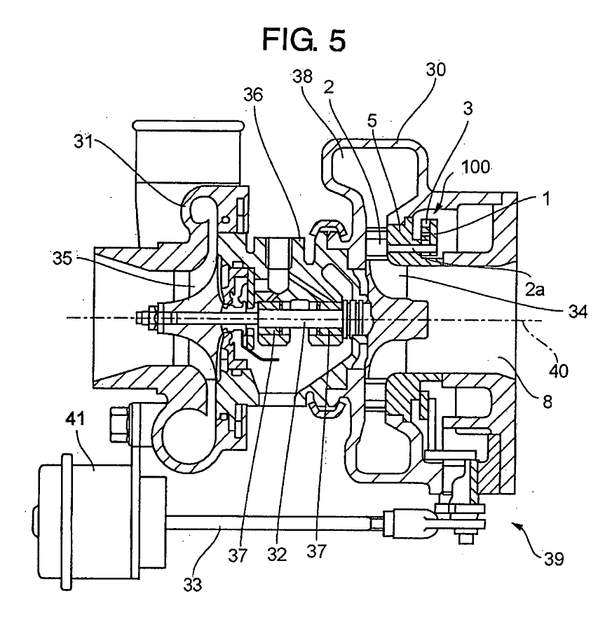

FIG. 5 is a longitudinal sectional view of the variable-throat turbocharger equipped with the variable throat mechanism according to the present invention.

Referring to FIG. 5, reference numeral 30 is a turbine casing, 38 is a scroll formed vorticosely in the peripheral part of the turbine casing 30. Reference numeral 34 is a turbine rotor of radial flow type, 35 is a compressor, 32 is a turbine shaft connecting the turbine rotor 34 to the compressor 35, 31 is a compressor housing, and 36 is a bearing housing.

The turbine shaft connecting the turbine rotor 34 to the compressor 35 is supported rotatably by the bearing housing 36 by means of two bearings 37, 37. Reference numeral 8 is an exhaust gas outlet, 40 is an axis of rotation of the exhaust turbo charger.

Reference numeral 2 is a nozzle vane, a plurality of the nozzle vanes are arranged at equal spacing in the inward side periphery of the scroll 38, and a nozzle shaft 2a formed at a side face of the nozzle vane is supported rotatably by a nozzle mount 2 fixed to the turbine casing 30.

Reference numeral 41 is an actuator, 33 is an actuator rod, and 39 is a drive mechanism connecting the actuator rod 33 to a driving ring 3, the drive mechanism converts reciprocating movement of the actuator rod into rotational movement of the drive ring.

Reference numeral 100 is a variable throat mechanism for varying the blade angle of the nozzle vanes 2.

In the operation of the variable-throat exhaust turbocharger equipped with the variable throat mechanism constructed as shown in FIG. 5, exhaust gas from an internal combustion engine (not shown in the drawing) enters the scroll 38 to flow along the volute of the scroll 38. The exhaust gas flows through passages between the nozzle vanes 2 into the turbine rotor 34 from the outer periphery thereof to flow radially inwardly exerting expansion work on the turbine rotor 34 to be exhausted in axial direction through the exhaust gas outlet 8 to the outside.

Control of the variable-throat turbocharger is carried out by the actuator 41 which acts to change the blade angle of the nozzle vanes 2 to an angle position so that the exhaust gas flows through the passage between the nozzle vanes 2 at a desired flow rate, said blade angle being determined by a blade angle control means not shown in the drawing. Reciprocal displacement of the actuator rod 33 is converted to rotational displacement of the drive ring by the medium of the drive mechanism 39.

By the rotation of the drive ring is swung each of lever plates 1 around the center axis of each of the nozzle shafts 2a via each of connecting pin parts 10 (or 11) to rotate each of the nozzle shafts 2a. The nozzle vanes are rotated by the rotation of the nozzle shafts 2a to change the blade angle to said desired angle position.

The present invention relates to an improvement of the variable throat mechanism 100 for controlling the flow rate of exhaust gas flowing through the variable-throat turbine like this.

### First Embodiment

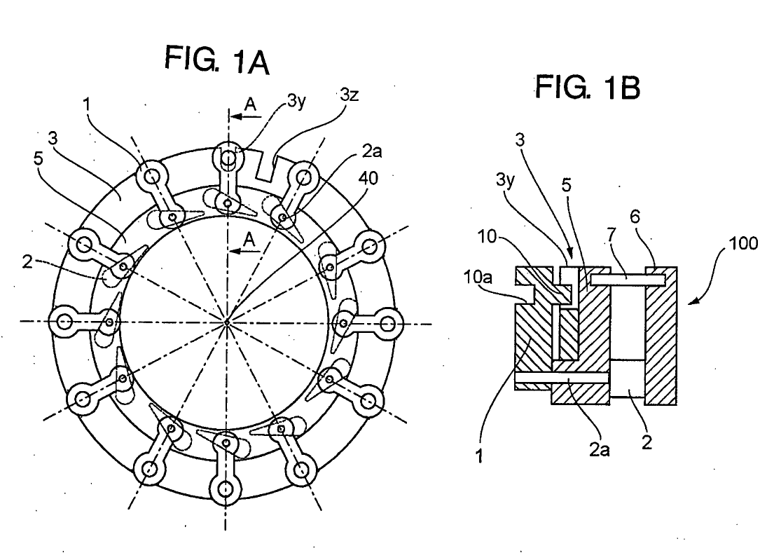

FIG. 1A is a front view of the first embodiment of the variable throat mechanism of the present invention viewed from the lever plate side, and FIG. 1B is a sectional view along line A-A in FIG. 1A.

Reference numeral 100 is a variable nozzle mechanism for varying the blade angle of the nozzle vanes 2 and constructed as follows.

Reference numeral 3 is a drive ring formed into an annular shape and supported rotatably by a nozzle mount 5. Grooves 3y are provided at the peripheral part of the drive ring 3 at equal spacing, each of connecting pin parts 10 explained later is engaged with each of the grooves. Reference numeral 3z is a driving groove with which a link of the drive mechanism 39 is engaged.

Reference numeral 1 indicates lever plates disposed on the peripheral part of the drive ring 3 corresponding to the grooves 3y in number.

Each of the lever plates 1 has a connecting pin part 10 formed on its face at the circumferentially outward side, and the nozzle shaft 2a of the nozzle vane 2 is fixed to the lever plate 1 at the inward side thereof.

Reference numeral 6 is a support plate formed into an annular shape, 7 indicates nozzle supports for connecting the support plate 6 to the nozzle mount 5.

In the variable nozzle throat mechanism 100, as shown in FIG. 1B, the lever plate 1 is disposed in the axially outer side (exhaust gas outlet side 8 in FIG. 5), and the drive ring 3 is disposed between a side face of the lever plate 1 and a side face of the nozzle mount 5 side by side with the lever plates 1 and nozzle mount 5 in axial direction thereof.

The connecting pin part 10 is formed by extrusion, in which a spot on a flat face of the lever plate 1 is pressed by a pressing machine to form a depressed portion 10a thereon to obtain a cylindrical projecting part on the other side flat face thereof, thus the connecting pin part 10 is formed in one piece with parent material, i.e. the lever plate 1.

The lever plate can be also made by precision casting to have the connecting pin part 10 integral with the lever plate.

At least one of the periphery of the connection pin part 10 and the surface of the groove 3y, into which is to be engaged the connecting pin part 10, of the drive ring 3, is treated by surface hardening such as chrome diffusion coating, aluminum diffusion coating, vanadium diffusion coating, niobium diffusion coating, boron diffusion coating, nitriding, or combined treating of said diffusion coating and carburizing.

To manufacture the variable throat mechanism 100 constructed as mentioned above, a connection pin part 10 is formed to protrude from the lever plate 1 in one piece therewith by pressing by a pressing machine a spot on a flat face of the lever plate 1 so that a cylindrically depressed portion 10a is formed on the other side flat face of the lever plate. On the drive ring 3 are formed the grooves 3y by machining, or the grooves 3y are formed by precision casting when the drive ring is made by precision casting.

Then, at least one of the periphery of the connection pin part 10 and the surface of the groove 3y, into which the connecting pin part 10 is to be engaged, of the drive ring 3, is treated for surface hardening as mentioned above.

### Second Embodiment

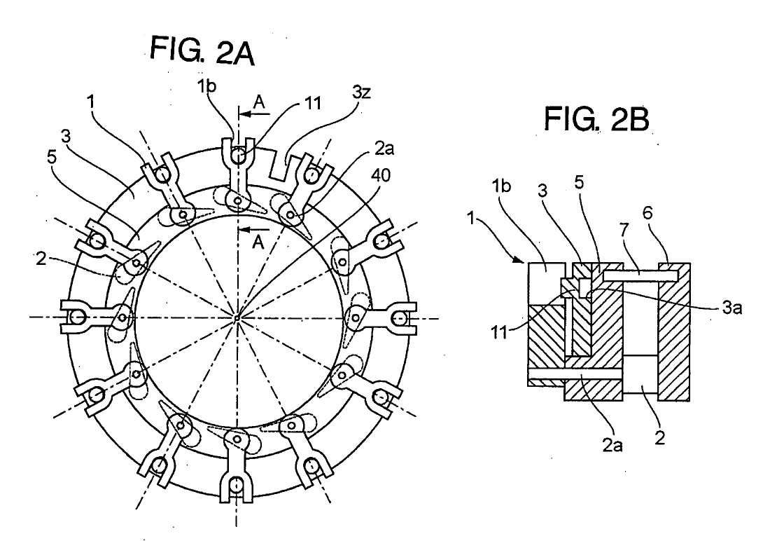

FIG. 2A is a front view of the second embodiment of the variable throat mechanism of the present invention viewed from the lever plate side, and FIG. 2B is a sectional view along line A-A in FIG. 2A.

In the second embodiment, a plurality of spots lining up circumferentially at equal spacing on a flat face of a drive ring 3 are pressed by a pressing machine to form cylindrical depressed portions 3a each of which is similar to that of the first embodiment to obtain cylindrical projecting parts on the other side flat face thereof, thus connecting pin parts 11 are formed in one piece with parent material, i.e. the drive ring 3. Each of lever plates 1 is formed to have two-forked part at the outward side thereof to form a groove 1b to be engaged with one of the connecting pin parts 11 of the drive ring 3.

Otherwise is identical in construction to the first embodiment, and constituent parts similar to those of the first embodiment are denoted by the same reference numerals respectively.

According to the first and second embodiment, the connecting pin parts 10 (11) can be easily formed integral with the parent material by using as material of the lever plate 1 or the drive ring 3 steel material tough but relatively soft and easy to process by extrusion and applying extrusion forming to either the lever plate 1 or drive ring 3, or by precision casting.

Further, by treating at least the connection pin parts 10 (11) or the grooves, into which the connection pin parts 10 (11) are to be engaged, with surface hardening including diffusion coating, their contact surfaces are increased in hardness and the occurrence of adhesion between the surfaces of the grooves and the connecting pin parts is prevented, with the result that abrasion of the contact surface of the connecting pin parts 10 (or 11) and grooves 3y (or 1b) can be reduced.

Thus, each of the connection pin parts 10 or parts 11 can be easily formed integral with each of the lever plates 1 or drive ring 3 by extrusion consisting of one stage of processing or by precision casting while attaining high durability of the contact surface by increasing the hardness of the contact surfaces of connection parts 10 (or 11) and grooves 3y (or 1b) to suppress wear of the contact surfaces, with the result that assembling man-hours and assembling cost can be reduced and the number of parts and manufacturing cost of the parts can be reduced compared with a variable threat mechanism in which the connection pins are provided separately and fixed to the lever plates or drive ring.

### Third Embodiment

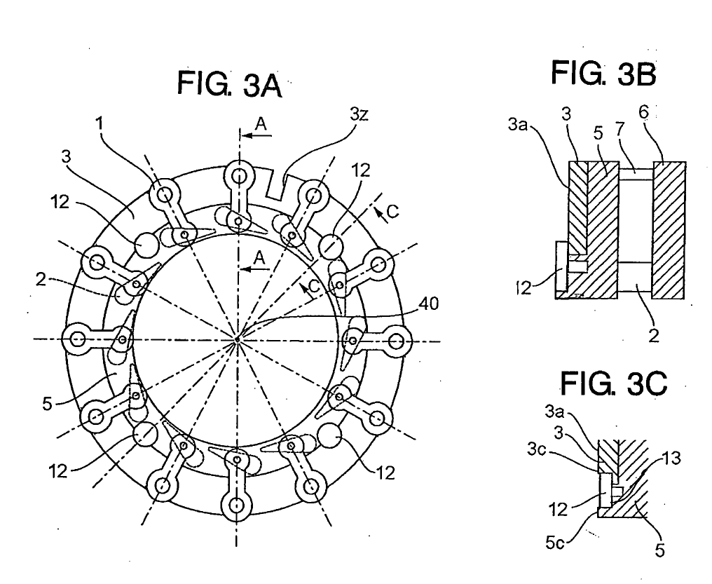

FIG. 3A is a front view of the third embodiment of the variable throat mechanism of the present invention viewed from the lever plate side, FIG. 3B is a sectional view along line A-A in FIG. 3A. FIG. 3C is a sectional view as along line C-C in FIG. 3A of a modification of the third embodiment. A section along line A-A in FIG. 3A of the third embodiment is the same as that shown in FIG. 1B and FIG. 2B.

In the third embodiment, a drive ring 3 is disposed between the side face of the lever plate 1 and the a side face of a nozzle mount 5 side by side with the lever plates 1 and nozzle mount 5 in axial direction thereof as is in the case of the first and second embodiment, and a plurality of rivets 12 are fixed to the nozzle mount 5 at its outer side face so that the outer side face 3a of the drive ring 3 can come into contact with the seating faces of the rivets 12 thereby to prevent the drive ring from slipping out towards the lever plate side.

In the third embodiment, it is also possible that recesses 13 are formed to stride across the outer side face 3c of the drive ring 3 and outer side face 5c of the nozzle mount 5, and the head of each of the rivets is received in each of the recesses thereby to evade the heads of the rivets from protruding than the outer side face of the lever plate 1.

According to the third embodiment, slipping out of the drive ring 3 in axial direction can be positively prevented by such an extremely compact, cost saving, and light-in-weight means as a plurality of rivets 12 (four rivets in the example shown in FIG. 3A) fixed to a side face of the nozzle mount 5, with the result that occurrence of failed action of the nozzle throat mechanism 100 caused by slipping out of the drive ring 3 in the axial direction.

Otherwise is identical in construction to those of the first embodiment, and constituent parts similar to those of the first embodiment are denoted by the same reference numerals respectively.

### Fourth Embodiment

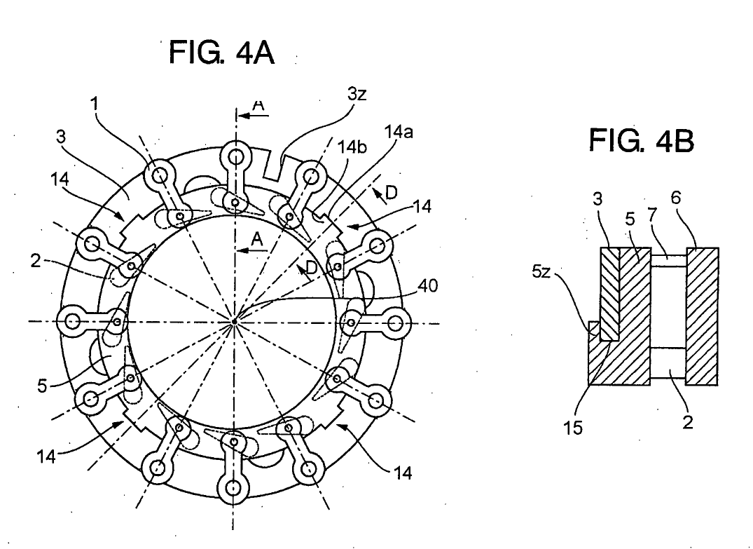

FIG. 4A is a front view of the second embodiment of the variable throat mechanism of the present invention viewed from the lever plate side, and FIG. 4B is a sectional view along line D-D in FIG. 4A. A section along line A-A in FIG. 3A of the fourth embodiment is the same as that shown in FIG. 1B.

In the fourth embodiment, a drive ring 3 is disposed between the side face of the lever plate 1 and the a side face of a nozzle mount 5 side by side with the lever plates 1 and nozzle mount 5 in axial direction thereof as is in the case of the first and second embodiment, and a plurality of partial circumferential grooves 15 are provided at the outer side part of the nozzle mount 5. The drive ring 3 is received in the partial circumferential grooves 15 and prevented by the side face of the groove 15 from slipping out towards the lever plate 1.

More specifically, as shown in FIG. 4A, a plurality of engaging parts 14 are provided which consists of a plurality of concave portions 14a formed on the inner periphery of the drive ring 3 and a plurality of convex portions 14b formed at the outer side face part 5z of the nozzle mount 5, the convex portions 14b forming outside walls of the partial circumferential grooves 15 and the bottoms of the partial circumferential grooves 15 coincide with the outer periphery of the stepped part of the nozzle mount 5.

When assembling the variable throat mechanism 100 of the fourth embodiment, the drive ring 3 is pushed towards the nozzle mount with the concave portions 14a of the drive ring 3 matched with the convex portions 14b of the nozzle mount 5 to fit the drive ring 3 on the inner periphery of the stepped part of the nozzle mount 5. Then the drive ring 3 is rotated by a certain rotation angle relative to the nozzle mount 5 so that the inner peripheral part of the drive ring is engaged with the partial circumferential grooves 15 to prevent the drive ring 3 from slipping in axial direction. Then the lever plates 1 are attached to the drive ring 3 and connected with the nozzle shafts 2a penetrating the nozzle mount 5, sandwiching the nozzle mount 2.

Otherwise is identical in construction to those of the first embodiment, and constituent parts similar to those of the first embodiment are denoted by the same reference numerals respectively.

According to the fourth embodiment, the drive ring 3 can be positively prevented from slipping out in axial direction by such a manner that requires no additional part and therefore does not result in increase in the number of parts and cost. By engaging the drive ring 3 into the partial circumferential grooves 15 formed at the side part 5z of the nozzle mount 5, and occurrence of fail in action of the variable throat mechanism can be prevented.

### Fifth Embodiment

In the fifth embodiment of the invention, in the variable exhaust turbocharger equipped with the variable nozzle throat mechanism 100 as shown in FIG. 1 to FIG. 4, a coating layer is formed either on the surface of the connection pin part 10 (or 11) or on the surface of the groove 3y (or 1b), (or on both the surfaces) by PVD processing (physical ion adsorption processing) or by CVD (chemical ion adsorption processing).

According to the fifth embodiment, by forming a hard coating layer on the contact surface of the connection pin part 10 (or 11) with the groove 3y (or 1b) into which the connection pin part 10 is engaged by PVD or CVD processing, the abrasive resistance of the contact surface is increased.

According to the present invention, a variable-throat exhaust turbocharger can be provided, in which is used a means to reduce wear of the contact surfaces of the connecting pin parts which are formed integral with the lever plates or the drive ring and the grooves into which the connection pin parts are engaged, and which is provided a means to prevent slipping out of the drive ring from the nozzle mount toward the lever plate to prevent probable occurrence of fail in action of the variable nozzle mechanism caused by the slipping out of the drive ring.

What is claimed is:

1. A variable-throat exhaust turbocharger equipped: with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes,
wherein a connecting pin is formed integral with said lever plate by extrusion or by precision casting as a connection pin parts of the lever plate or connecting pins are formed integral with said drive ring by extrusion or by precision casting as connection pin parts of the drive ring, wherein at least either the connection pin part of the lever plate/pin parts of the drive ring or grooves of the drive ring/groves of the lever plates into which the connection pin parts are engaged are treated with surface hardening including diffusion coating.

2. A variable-throat exhaust turbocharger equipped with a variable throat mechanism according to claim 1,
wherein said drive ring is disposed between said lever plates and nozzle mount side by side with the lever plates and nozzle mount in axial direction thereof, and a connection pin part or parts are formed protruding from a side face of the lever plate or the drive ring and integral with the material of the lever plate or the drive ring, whereby the connection pin parts of the lever plates or pin parts of the drive ring are engaged into the grooves of the drive pins or grooves of the lever plates.

3. A method for manufacturing a variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end connected to the drive ring via a connection pin and a groove into which the connection pin is engaged and at the other end to the nozzle vanes, whereby the lever plates are swung by rotating the drive ring and the nozzle vanes are rotated by the swing of the lever plates to vary the blade angle of the nozzle vanes,
wherein a connection pin part is formed on a lever plate in one piece with the lever plate by pressing a spot on a flat face thereof to allow the pin part to be protruded from the other side flat face thereof or is formed by precision casting on a flat face of a lever plate in one piece with the lever plate, or a plurality of connection pin parts are formed on a drive ring in one piece with the drive ring by pressing a plurality of spots on a flat face thereof to allow the pin parts to be protruded from the other side flat face of the drive ring or are formed by precision casting on a flat face of a drive ring in one piece with the drive ring, then at least either the connection pin part of the lever plate/pin parts of the drive ring or grooves of the drive ring/groves of the lever plates are treated with surface hardening including diffusion coating.

4. A variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes,
wherein said drive ring is disposed between said lever plates and nozzle mount side by side with the lever plates and nozzle mount in axial direction thereof, and rivets are fixed to the nozzle mount at its outside face so that the outer side face of the drive ring 3 can comes into contact with the seating faces of the rivets thereby to prevented the drive ring from moving axially.

5. A variable-throat exhaust turbocharger equipped with a variable throat mechanism according to claim 4,
wherein recesses are formed to stride across the outer side face of the drive ring and outer side face of the nozzle mount and the head of each of the rivets is received in each of the recesses.

6. A variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes,
wherein said drive ring is disposed between said lever plates and nozzle mount side by side with the lever plates and nozzle mount in axial direction thereof, and a plurality of partial circumferential grooves are provided at the outer side part of the nozzle mount, thereby receiving the drive ring in the partial circumferential grooves and preventing the drive ring from moving in axial direction.

7. A variable-throat exhaust turbocharger equipped with a variable throat mechanism according to claim 6,
wherein a plurality of engaging portions are provided, the engaging portions being composed of convex portions and concave portions provided either to the drive ring or nozzle mount respectively, so that the drive ring can be fitted to the nozzle mount by matching the convex portions and concave portions and shifting axially the drive ring relative to the nozzle mount, whereby the drive ring is allowed to be engaged into said partial circumferential grooves by shifting the drive ring in rotation direction after the drive ring is fitted to the nozzle mount.

8. A method for manufacturing a variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes,
wherein said drive ring is disposed between said lever plates and nozzle mount, the nozzle mount being provided with a plurality of partial circumferential grooves at the outer side part thereof, side by side with the lever plates and nozzle mount in axial direction thereof, and a plurality of engaging portions are provided, the engaging portions being composed of convex portions and concave portions provided either to the drive ring or nozzle mount respectively, so that the drive ring can be fitted to the nozzle mount by matching the convex portions and concave portions and shifting axially the drive ring relative to the nozzle mount, whereby the drive ring is allowed to be engaged into said partial circumferential grooves by shifting the drive ring in rotation direction by a certain angle after the drive ring is fitted to the nozzle mount thereby to prevent slipping out axially of the drive ring, and wherein said lever plates are attached to said drive ring and connected with nozzle shafts of the nozzle vanes, the nozzle shafts penetrating the nozzle mount, with the nozzle mount sandwiched with the lever plates and nozzle vanes.

9. A variable-throat exhaust turbocharger equipped with a variable throat mechanism comprising a plurality of nozzle vanes supported rotatably by a nozzle mount fixed to a turbine casing, an annular drive ring connected to and rotated by an actuator, and lever plates identical in number with the number of the nozzle vanes, each of the lever plates being connected at its one end to the drive ring via a connection pin and a groove into which the connection pin is engaged and at the other end connected to the nozzle vanes, whereby the lever plates are swung by rotating the drive ring and the nozzle vanes are rotated by the swing of the lever plates to vary the blade angle of the nozzle vanes,
wherein a coating layer is formed either on the surface of the connection pin part or on the surface of the groove into which the connection pin part is engaged by PVD processing (physical vapor deposition processing) or by CVD (chemical vapor deposition processing).
